(19) United States
(12) Patent Application Publication
(10) Pub. No.: US 2014/0028523 A1
(43) Pub. Date: Jan. 30, 2014

(54) ANTENNA DEVICE FOR ELECTROMAGNETIC MEASUREMENT

(71) Applicant: XIAO-LIAN HE, Shenzhen City (CN)

(72) Inventor: XIAO-LIAN HE, Shenzhen City (CN)

(73) Assignees: HON HAI PRECISION INDUSTRY CO., LTD., Tu-Cheng (TW); HONG FU JIN PRECISION INDUSTRY (ShenZhen) CO.,LTD., Shenzhen City (CN)

(21) Appl. No.: 13/587,950

(22) Filed: Aug. 17, 2012

(30) Foreign Application Priority Data
Jul. 30, 2012 (CN) 2012102658276

(51) Int. Cl. H01Q 3/04; H01Q 3/02

(52) U.S. Cl. 343/882; 343/880

(57) ABSTRACT

An antenna device includes a base, four adjusting apparatuses, two connecting poles each connected between two the adjusting apparatuses, a first slide apparatus with a first motor fitted around each connecting pole, a supporting pole, and an antenna. Each adjusting apparatus includes a pole perpendicularly extending up from the base, a second slide apparatus fitted around the pole, and a second motor installed in the base and connecting the second slide apparatus. Two ends of each connecting pole are respectively mounted to the corresponding second slide apparatuses. The supporting pole is installed to the first slide apparatus, and the antenna is attached to an end of the supporting pole. Each first motor drives the first slide apparatus to move along a lengthwise direction of the connecting pole. Each second motor drives the second slide apparatus to move along a lengthwise direction of the corresponding pole.

### BACKGROUND

1. Technical Field

The present disclosure relates to an antenna device for electromagnetic measurement.

2. Description of Related Art

In electromagnetic measurement, such as electromagnetic interference measurement, a test antenna is rotatably installed to a supporting pole for measuring information technology equipment (ITE), such as personal computers, liquid crystal displays, or mobile phones. The test antenna needs to align with the ITE during measuring. However, the test antenna needs to be moved relative to the ITE for measuring the maximum intensity of electromagnetic radiations generated by the ITE, which is time-consuming and inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an exemplary embodiment of an antenna device.

FIG. 2 is an exploded, isometric view of FIG. 1.

FIG. 3 is an enlarged view of the circled portion III of FIG. 1.

FIG. 4 is an assembled, isometric view of FIG. 2, showing the antenna device in use.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

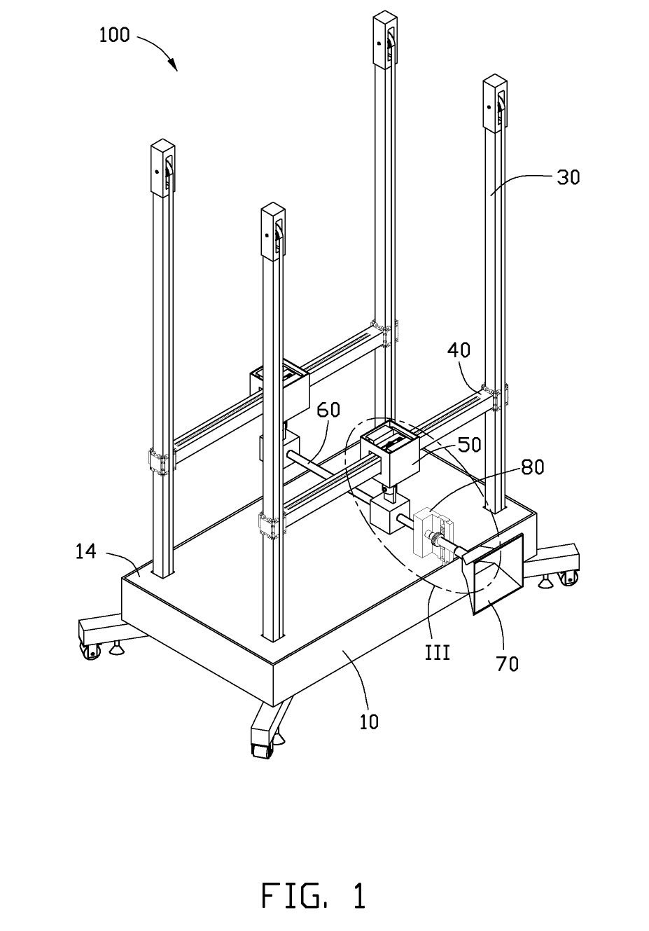

FIG. 1 shows an exemplary embodiment of an antenna device 100. The antenna device 100 can be used to measure the intensity of electromagnetic radiations generated by an information technology equipment (ITE), such as a personal computer, a liquid crystal display, or a mobile telephone. The antenna device 100 includes a rectangular base 10, four adjusting apparatuses 30, two connecting poles 40, two slide apparatuses 50, a supporting pole 60, and an antenna 70. The adjusting apparatuses 30 are respectively installed on four corners of the base 10. Each connecting pole 40 is connected between two of the adjusting apparatuses 30 at a side of the base 10. The slide apparatuses 50 are slidably installed to the connecting poles 40, respectively. The supporting pole 60 is installed to the slide apparatuses 50. The antenna 70 is rotatably installed to a first end of the supporting pole 60 through a rotation apparatus 80.

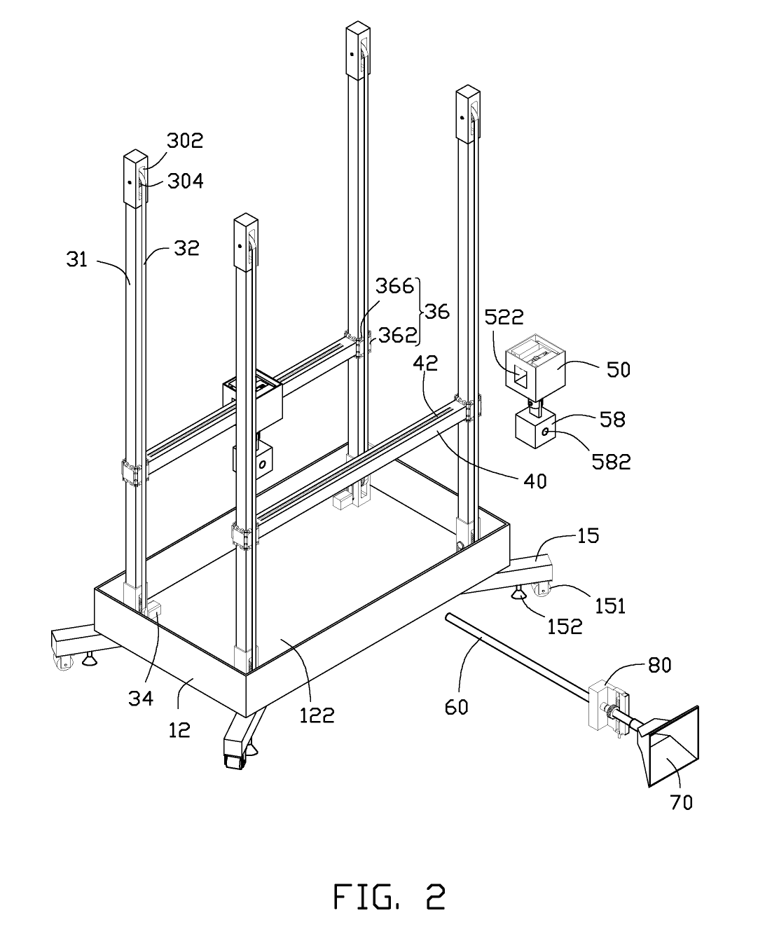

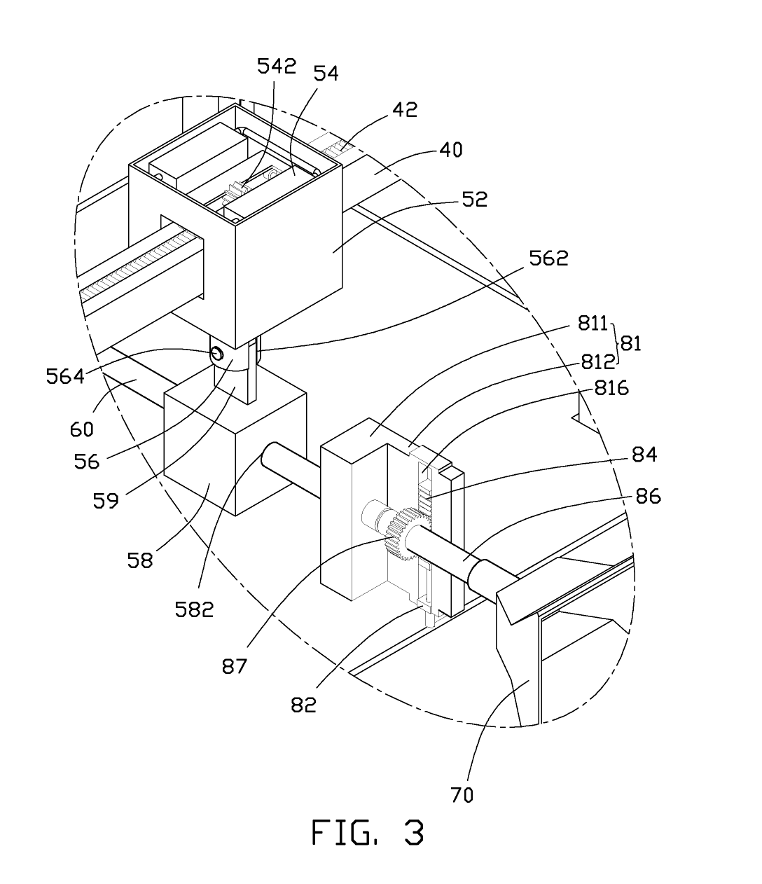

Referring to FIG. 2 and FIG. 3, the base 10 includes a rectangular shell 12, a cover 14 covered on the base 10, and a holder 15 mounted on the underside of the shell 12. The holder 15 is substantially cross-shaped and includes four conveying wheels 151, and four feet 152 mounted on the underside of the holder 16. The four conveying wheels 151 are rotatably mounted on four distal ends of the holder 15. Therefore, the holder 15 and the base 10 can be horizontally moved due to rotation of the conveying wheels 151. Each foot 152 is positioned adjacent to a corresponding conveying wheel 151, for retaining the holder 15 in predetermined locations.

Each adjusting apparatus 30 includes a pole 31, a transmission belt 32, a first motor 34, and a slide apparatus 36. A bottom end of the pole 31 is perpendicularly mounted on a bottom plate of the shell 12 and extends through the cover 14. Two longitudinal through holes 302 are respectively defined in top and bottom ends of the pole 31. Each through hole 302 extends through opposite sides of the pole 31. An adjusting pulley 304 is rotatably mounted in each through hole 302. The transmission belt 32 is coiled between the adjusting pulleys 304 and is pulled to extend longitudinally along the pole 31 by the first motor 34. The first motors 34 are synchronous motors. A rotation of the adjusting pulleys 304 can drive the transmission belt 32 to move along a lengthwise direction of the pole 31.

The slide apparatus 36 includes four connecting plates 362 connected end to end to form a rectangular frame slidably fitted around the pole 31. Each of a top and a bottom of each connecting plate 362 is installed with a shaft. Two rollers 366 are rotatably fitted about each shaft and are rolled along the pole 31. A part of the transmission belt 32 is fixedly extended through one of the connecting plate 362. In this way, movements of the transmission belt 32 along the pole 31 can drive the slide apparatus 36 to slide along the pole 31.

Each connecting pole 40 is substantially rectangular. Two opposite ends of the connecting pole 40 are respectively mounted to the corresponding connecting plates 366 of two opposite slide apparatuses 36. A top surface of the connecting pole 40 defines a rack 42 along a lengthwise direction of the connecting pole 40.

Each slide apparatus 50 includes a casing 52, a second motor 54 received in the casing 52, an extension pole 56 rotatably connected to a bottom of the casing 52, a connecting block 58, and a connecting piece 59 extending up from the connecting block 58 and connected to the extension pole 56. A rotation axis of the extension pole 56 is parallel to the lengthwise direction of the pole 31. Two opposite sides of the casing 52 each define a guiding hole 522 for allowing the corresponding connecting pole 40 to extend there through. The second motor 54 includes a gear pulley 542 meshing with the rack 42 of the connecting pole 40. A bottom end of the extension pole 56 defines a rectangular cutout 562. A first end of the connecting piece 59 is inserted into the cutout 562 and is rotatably connected to the extension pole 56 through a shaft 564. A second end of the connecting piece 59 opposite to the extension pole 56 is fixed on a top surface of the connecting block 58. The connecting block 58 defines a through hole 582. In the embodiment, the second motor 54 is a pneumatic motor to avoid electromagnetic radiation.

A second end of the supporting pole 60 slidably extends through the through hole 582 of one of the connecting blocks 58, and is fixed in the through hole 582 of the other connecting block 58. A middle of the supporting pole 60 can be slid in the through hole 582 adjacent to the antenna 70.

The rotation apparatus 80 includes a substantially L-shaped installation bracket 81 installed to the first end of the supporting pole 60, a cylinder 82, a rack 84 slidably extending through the cylinder 82, and a rotation pole 86. The installation bracket 81 includes a rectangular first plate 811 fixed to the supporting pole 60, and a second plate 812 perpendicularly extending from a side of the first plate 811 away from the connecting block 58. The second plate 812 defines a slot 816 parallel to the first plate 811, for receiving the rack 84 and the cylinder 82. A gear pulley 87 is installed to the rotation pole 86, to mesh with the rack 84. A first end of the rotation pole 86 axially defines a shaft hole (not shown) for rotatably receiving the first end of the supporting pole 60. The antenna 70 is installed to a second end of the rotation pole 86 opposite to the rotation apparatus 80. The gear pulley 87 is firmly fitted about a middle of the rotation pole 86.

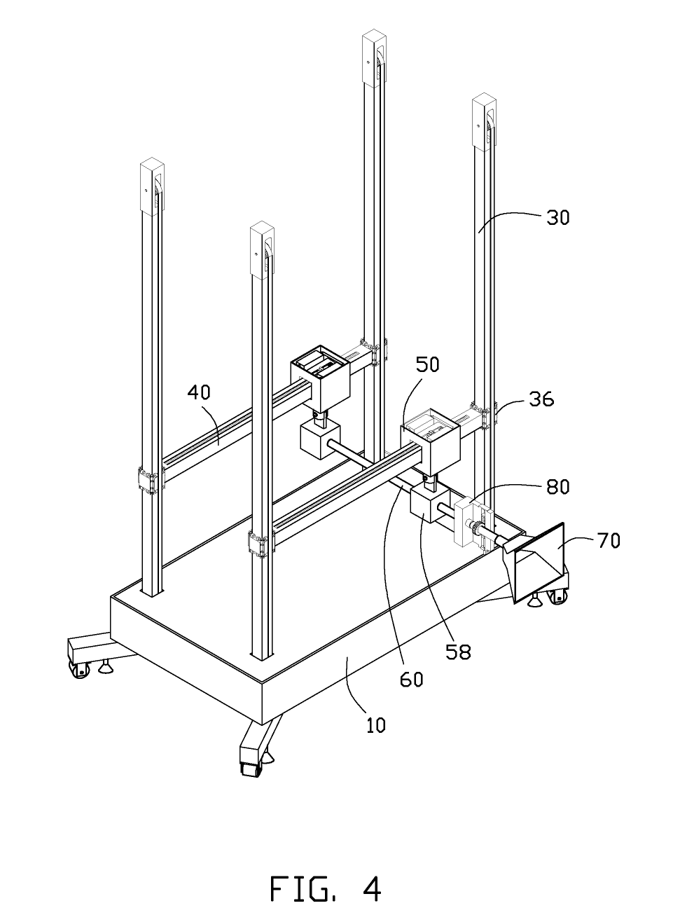

Referring to FIG. 4, in use, the first motors 34 drive the slide apparatuses 36 to move along a lengthwise direction of the corresponding poles 31. The second motors 54 drive the slide apparatuses 50 to move along a lengthwise direction of the connecting poles 40. The supporting pole 60 can be expediently adjusted to the height and the obliquity, to allow the antenna 70 to align with the ITE. The cylinder 82 drives the rack 84 to move along the slot 816 to allow the antenna 70 to rotate about the supporting pole 60.

Even though numerous characteristics and advantages of the embodiments have been set forth in the foregoing description, together with details of the structure and function of the embodiments, the present disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. An antenna device, comprising:
a base;
four adjusting apparatuses each comprising a pole perpendicularly extending up from the base, a first slide apparatus slidably fitted around the pole, and a first motor installed in the base and connected to the first slide apparatus;
two connecting poles each connecting two of the adjusting apparatuses;
two second slide apparatuses slidably fitted around the connecting poles, respectively, each second slide apparatus comprising a second motor;
a supporting pole installed to the second slide apparatuses; and
an antenna installed to an end of the supporting pole, wherein two opposite ends of each connecting pole are respectively mounted to the first slide apparatuses of the two corresponding adjusting apparatuses, the first motors drive the first slide apparatuses to move along a lengthwise direction of the poles, the second motors drive the second slide apparatuses to move along a lengthwise direction of the connecting poles.

2. The antenna device of claim 1, wherein a top surface of each connecting pole defines a rack along a lengthwise direction of the connecting pole, each second slide apparatus comprises a casing slidably fitted around the corresponding connecting pole, the second motor comprises a gear pulley installed in the casing and meshing with the rack of the connecting pole.

3. The antenna device of claim 2, wherein two opposite sides of each casing defines a guiding hole through which the connecting pole extends.

4. The antenna device of claim 2, where each second slide apparatus further comprises an extension pole rotatably connected to a bottom of the casing, and a connecting block rotatably connected to the extension pole, the supporting pole is attached to the connecting blocks.

5. The antenna device of claim 4, where a connecting piece extends up from a top of the connecting block, and is rotatably connected to a bottom end of the extension pole.

6. The antenna device of claim 4, where each connecting block defines a through hole, the first end of the supporting pole is slidably extended through the through hole of one of the connecting blocks, and fixed to the through hole of the other connecting block.

7. The antenna device of claim 1, wherein each adjusting apparatus further comprises a transmission belt, each of top and bottom ends of the pole defines a longitudinal through hole, an adjusting pulley is rotatably mounted in each through hole, the transmission belt is coiled on the adjusting pulleys, the first motor is configured to drive the transmission.

8. The antenna device of claim 7, wherein each first slide apparatus comprises four connecting plates connected end to end to form a frame slidably fitted around the pole, a part of the transmission belt is fixedly extended through one of the connecting plates, two ends of the connecting pole are mounted to two opposite connecting plates of the corresponding first slide apparatuses.

9. The antenna device of claim 1, wherein the base comprises a rectangular shell, the adjusting apparatuses are respectively installed to four corners of the shell, each first motor is installed in the shell adjacent to the corresponding adjusting apparatus.

10. The antenna device of claim 1, wherein the first motors are synchronous motors.

11. The antenna device of claim 1, wherein each second motor is a pneumatic motor.

12. The antenna device of claim 1, further comprising a rotation apparatus, wherein the rotation apparatus comprises an installation bracket mounted to the second end of the supporting pole, a cylinder, a rack slidably installed in the installation bracket through the cylinder along a direction perpendicular to the lengthwise direction of the supporting pole, and a rotation pole, a first end of the rotation pole is rotatably connected to the supporting pole, the antenna is mounted to a second end of the rotation pole, a gear pulley is fitted about the rotation pole and meshes with the rack of the rotation apparatus.
